(19) United States
(12) Patent Application Publication
(10) Pub. No.: US 2012/0179779 A1
(43) Pub. Date: Jul. 12, 2012

(54) SYSTEM AND METHOD FOR DATA STORAGE AND RETRIEVAL

(75) Inventor: Vishal Awasthi, Aston, PA (US)

(73) Assignee: Dolphin Enterprise Solutions Corporation d/b/a Dolphin, Morgan Hill, CA (US)

(21) Appl. No.: 13/348,788

(22) Filed: Jan. 12, 2012

Related U.S. Application Data
(60) Provisional application No. 61/431,915, filed on Jan. 12, 2011.

(51) Int. Cl. G06F 15/16

(52) U.S. Cl. 709/217

(57) ABSTRACT

A scheme for a business-software application system (e.g., SAP) to access cloud storage (e.g., AT&T Synaptic Storage-as-a-Service) by means of an add-on enabler software module, where applications can use cloud storage as an archive (e.g., ArchiveLink) repository. In one embodiment, a business-software application system includes an application server and an enabler. The application server is configured to execute a plurality of applications and includes an archiving module. The enabler is adapted to exchange application data with (i) the archiving module, and, (ii) via a secure connection, a cloud-storage repository. In one embodiment, the enabler employs the SAP ArchiveLink protocol to communicate with the archiving module and is adapted to make signed Representational State Transfer (REST) HTTP calls through the ABAP language.

### CROSS-REFERENCE TO RELATED APPLICATION

This application claims priority to co-pending U.S. Provisional Patent Application Ser. No. 61/431,915, filed Jan. 12, 2011, the disclosure of which is incorporated herein by reference in its entirety.

### BACKGROUND OF THE INVENTION

1. Field of the Invention

The present invention relates, generally, to remote data storage and retrieval, and more specifically but not exclusively, to data-storage schemes for SAP systems employing cloud resources.

2. Description of the Related Art

Systeme, Anwendungen, Produkte (German for “Systems Applications and Products”), more commonly known as SAP, is an enterprise information and management software package for tracking and managing data relevant to an enterprise, including sales, production, finance, accounting, and human resources.

SAP software, which is used worldwide, can be customized to suit a customer's needs and employs many tools to integrate and link third-party systems and software. SAP software can also execute on multiple hardware platforms. Data in a typical SAP enterprise resides in a central database shared by SAP components. The central database can be embodied in a database such as Oracle, Informix, Online, Adabas, DB2, DB/400, and Microsoft SQL Server 6.

To accommodate a high level of integration between SAP and external applications and systems, an SAP software system can be accessed via one or more Business-Application Programming Interfaces (BAPIs), which provide access to an SAP database either from within SAP or from other development platforms and third-party applications external to SAP that support an SAP protocol known as Remote Function Call (RFC) protocol. BAPIs, SAP applications, and parts of SAP's basic system are developed using SAP's Advanced Business-Application Programming (ABAP) language, which is used for customization and modification of SAP applications.

The central database of an SAP software system has conventionally been stored in a central attached storage repository, which arrangement results in a number of limitations. For example, companies must purchase and maintain physical storage devices in their own datacenter or offices. To avoid running out of space, companies must often purchase more file-storage space than they actually need. Additionally, companies must be equipped to handle administrative storage-maintenance tasks, including backup, data replication, and purchasing additional storage devices as needed. Also disadvantageous is the limitation of not being able to access the central database from any desired physical location.

### SUMMARY OF THE INVENTION

Thus, there is a need for a scheme that permits an SAP central database to be stored “in the cloud,” i.e., at an off-site storage system maintained by a third party. Advantageously, a cloud-based storage system for an SAP software system permits companies to avoid the need for installing physical data-storage devices in their own datacenter, allows companies to pay only for the amount of storage actually used, since storage can be provisioned dynamically. Moreover, in a cloud-based system, maintenance tasks, such as backup, data replication, and purchasing additional storage devices, are the responsibility of a service provider, which permits companies to focus on their core business without being sidetracked by work associated with storage maintenance. Furthermore, a cloud-based data system permits users to access an SAP central database from virtually any physical location where an Internet connection is available.

Accordingly, embodiments of the present invention provide a scheme for a business-software application system (e.g., SAP) to access cloud storage (e.g., AT&T Synaptic Storage-as-a-Service) by means of an add-on enabler software module, where applications can use cloud storage as an archive (e.g., ArchiveLink) repository.

In one embodiment, the present invention provides a business-software application system includes a first application server and an enabler. The first application server is configured to execute a plurality of applications and includes an archiving module. The enabler is adapted to exchange application data with (i) the archiving module, and, (ii) via a secure connection, a cloud-storage repository.

In another embodiment, the present invention provides an enabler-implemented method for a business-software application system to access a cloud storage repository. The business-software application system includes a first application server and an enabler. The first application server is configured to execute a plurality of applications and includes an archiving module. The enabler is adapted to exchange application data with (i) the archiving module, and, (ii) via a secure connection, a cloud-storage repository. The method includes at least one of: (i) the enabler receiving application data from the archiving module and providing the received application data to the cloud-storage repository; and (ii) the enabler receiving application data from the cloud-storage repository and providing the received application data to the archiving module.

In a further embodiment, the present invention provides a non-transitory machine-readable medium having encoded thereon program code, wherein, when the program code is executed by a machine, the machine implements a method for a business-software application system to access a cloud storage repository. The business-software application system includes a first application server and an enabler. The first application server is configured to execute a plurality of applications and includes an archiving module. The enabler is adapted to exchange application data with (i) the archiving module, and, (ii) via a secure connection, a cloud-storage repository. The method includes at least one of: (i) the enabler receiving application data from the archiving module and providing the received application data to the cloud-storage repository; and (ii) the enabler receiving application data from the cloud-storage repository and providing the received application data to the archiving module.

### BRIEF DESCRIPTION OF THE DRAWINGS

FIG. 1 is a block diagram depicting an exemplary single-server SAP software system with cloud storage, in accordance with a first embodiment of the invention;

FIG. 2 is a block diagram depicting an exemplary dual-server SAP software system with cloud storage, in accordance with a second embodiment of the invention;

FIG. 3 is a screen view depicting an exemplary parameter-entry window for an archive;

FIG. 4 is a screen view depicting an exemplary content-repository mapping table;

FIGS. 5-8 are screen views depicting exemplary performance and collection monitoring windows;

FIGS. 9-11 are screen views depicting exemplary spool administration windows;

FIG. 12 is a screen view depicting an exemplary queue-creation window;

FIGS. 13 and 14 are screen views depicting exemplary job-scheduling windows;

FIG. 15 is a screen view depicting an exemplary number-range window;

FIG. 16 is a screen view depicting an exemplary ArchiveLink settings window; and

FIGS. 17 and 18 are screen views depicting exemplary archive-format parameter windows.

### DETAILED DESCRIPTION

### Single-Server Embodiment

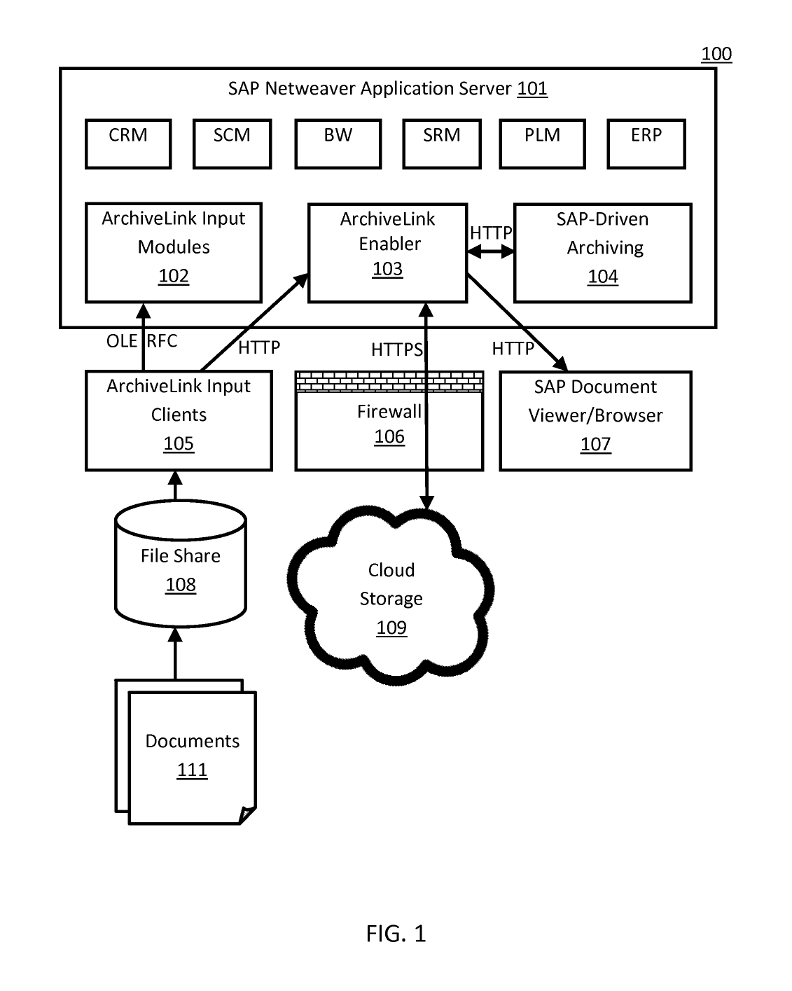

FIG. 1 depicts an exemplary single-server SAP software system 100 with cloud storage, consistent with a first embodiment of the invention. In this embodiment, SAP system 100 includes an SAP Netweaver application server 101, one or more ArchiveLink Input (ALI) clients 105, a firewall 106, an SAP document viewer/browser 107, a file share 108, and cloud storage 109. Server 101 includes one or more ArchiveLink input modules 102, an ArchiveLink enabler 103, and an SAP-driven archiving module 104.

Server 101 employs the SAP ABAP language and may include one or more SAP application modules, such as Customer-Relationship Management (CRM), Supply-Chain Management (SCM), Business Warehouse (BW), Supplier-Relationship Management (SRM), Product-Lifecycle Management (PLM), and Enterprise-Resource Planning (ERP). ArchiveLink input modules 102 receive Remote Function Calls (RFCs) and application data in an Object Linking and Embedding (OLE) format, from the one or more ArchiveLink input clients 105. ArchiveLink input clients 105 (i) receive input application data from a file share 108, on which a plurality of documents 111 (e.g., scanned or generated documents) reside, and (ii) provide output application data in HTTP form to ArchiveLink enabler 103. ArchiveLink enabler 103 sends application data to be stored on cloud storage 109 and receives application data retrieved from cloud storage 109 via HTTPS transport through firewall 106. ArchiveLink enabler 103 also (i) provides application data in HTTP format to SAP-driven archiving module 104 and SAP Document Viewer/Browser 107, and (ii) receives application data in HTTP format from SAP-driven archiving module 104. The arrangement of file share 108, ArchiveLink input clients 105, ArchiveLink input modules 102, and ArchiveLink enabler 103 permits inbound document archiving.

### Dual-Server Embodiment

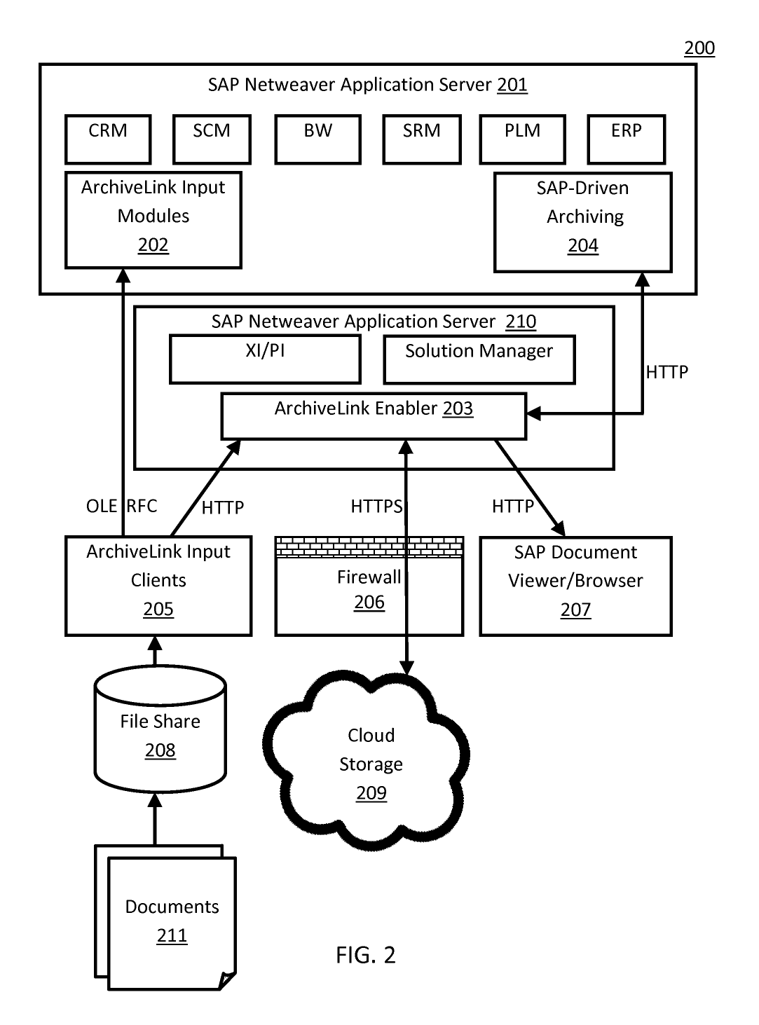

FIG. 2 depicts an exemplary dual-server SAP software system 200 with cloud storage, consistent with a second embodiment of the invention. In this embodiment, SAP system 200 includes a first SAP Netweaver application server 201, a second SAP Netweaver application server 210, one or more ArchiveLink Input (ALI) clients 205, a firewall 206, an SAP document viewer/browser 207, a file share 208, and cloud storage 209. Server 201 includes one or more ArchiveLink input modules 202 and an SAP-driven archiving module 204. Server 210 employs the SAP ABAP language and includes an ArchiveLink enabler 203 and may further include one or more SAP application modules, such as SAP Exchange Infrastructure (SAP XI) and SAP Process Integration (SAP PI).

Server 201 employs the SAP ABAP language and may include one or more SAP application modules, such as Customer-Relationship Management (CRM), Supply-Chain Management (SCM), Business Warehouse (BW), Supplier-Relationship Management (SRM), Product-Lifecycle Management (PLM), and Enterprise-Resource Planning (ERP). ArchiveLink input modules 202 receive Remote Function Calls (RFCs) and application data in an Object Linking and Embedding (OLE) format, from the one or more ArchiveLink input clients 205. ArchiveLink input clients 205 (i) receive input application data from a file share 208, on which a plurality of documents 211 (e.g., scanned or generated documents) reside, and (ii) provide output application data in HTTP form to ArchiveLink enabler 203. ArchiveLink enabler 203 sends application data to be stored on cloud storage 209 and receives application data retrieved from cloud storage 209 via HTTPS transport through firewall 206. ArchiveLink enabler 203 also (i) provides application data in HTTP format to SAP-driven archiving module 204 and SAP Document Viewer/Browser 207, and (ii) receives application data in HTTP format from SAP-driven archiving module 204. The arrangement of file share 208, ArchiveLink input clients 205, ArchiveLink input modules 205, and ArchiveLink enabler 203 permits inbound document archiving.

### ArchiveLink Enabler

The functionality and operation of an ArchiveLink enabler consistent with the invention will now be described. It should be understood that the following description applies both to ArchiveLink enabler 103 of system 100 and to ArchiveLink enabler 203 of system 200, as well as related components of both system 100 and system 200.

In some embodiments, the ArchiveLink enabler is provided as a single (external) SAP transport (e.g., for SAP NetWeaver 6.40 or higher), including workbench objects relating to the package/development class/DOL/ALE. The transport is imported using the SAP Transport Management System (STMS) and is client-independent. Once installed and activated, depending on the choice of cloud network provider, content repository-specific connection information is entered in the ArchiveLink enabler configuration, as will be described in further detail below.

The processing logic of the ArchiveLink enabler is contained in ABAP classes and exposed through the Internet Communication Manager (ICM) HTTP service to the appropriate native or remote ArchiveLink applications (as shown, e.g., in FIGS. 1 and 2). A connection to one or more cloud-storage providers is achieved through a native HTTP client that is built into the SAP NetWeaver application server. This configuration allows both the provider and consumer aspects of the ArchiveLink enabler to be self-contained, within the NetWeaver application server.

As shown in FIG. 1, the ArchiveLink enabler can be configured to run on the same application server as SAP business applications (e.g., ERP or CRM). This configuration natively allows support for all ArchiveLink scenarios without any external server component.

Alternatively, as shown in FIG. 2, the ArchiveLink enabler can be configured to run on an isolated application server that is used for system integration or management components from SAP (e.g., PI or solution manager). In this configuration, the ArchiveLink enabler is implemented on a remote NetWeaver application server, which can be shared, e.g., with XI/PI or Solution Manager components. On large SAP installations, this arrangement allows separation of business applications from integration components, such as the ArchiveLink enabler.

The ArchiveLink service is an SAP service integrated into an SAP server for linking archived documents and the application documents entered in the SAP system. A conventional SAP ArchiveLink server is a connector that employs a server infrastructure outside of the SAP application and links enterprise-content management (ECM), document management, and/or local-storage devices to SAP applications for long-term storage of documents and archived data.

The ArchiveLink enabler, in embodiments of the present invention, is a connector (i.e., an add-on software module) to the SAP software suite that allows users of SAP applications to use cloud storage, e.g., AT&T Synaptic Storage-as-a-Service, as an ArchiveLink repository. Through this arrangement, users of SAP solutions can achieve the operational cost savings possible with cloud storage, while maintaining seamless access to data and documents. Further, adding a cloud storage tier permits users to align the cost of storage with the value of their data, freeing SAP users to invest in high-performance access for current and/or frequently-used data, while shifting seldom-used data and documents to lower-cost and practically infinitely-elastic cloud storage services. With data-storage and archiving needs constantly rising, cloud-based storage-as-a-service offerings such as AT&T Synaptic and Amazon S3 are clearly viable and cost-effective alternatives to constant expansion of in-house infrastructure (i.e., on-premise options for housing the archived content).

The ArchiveLink enabler has an interface that leverages the SAP NetWeaver server's built-in secure communication capabilities to connect to cloud storage. Thus, a relatively lean ArchiveLink-server architecture can be used, residing in the SAP landscape as an SAP ABAP add-on, without the need for any additional infrastructure component (e.g., ArchiveLink for various structured and unstructured content-storage servers, operating systems, databases, security, etc.). This direct connection to cloud storage offers a better implementation than the classic file system-based cloud-connection options, where content is streamed to and from the cloud through an intermediate file system. The result is faster performance and byte/offset based access to the archived content, which can be critical, e.g., for efficient retrieval of archived SAP data and print lists.

Because the ArchiveLink enabler implements the SAP ArchiveLink protocol, all existing applications in the SAP solution that use ArchiveLink for various structured and unstructured content storage can seamlessly use cloud storage for those operations, such as: outbound-document archiving (e.g. SAP billing output), inbound-document archiving (e.g. inbound accounts-payable invoices), SAP print-list archiving, SAP data archiving, SAP data-retention tool (DART) file archiving, and SAP Knowledge Provider (KPro)-based content storage (e.g. SAP Document-Management System (DMS) and SAPOffice).

In embodiments of the present invention, the SAP file system is not merely mapped to the cloud, but rather, a more unique approach is used, with the following technical characteristics:

First, the SAP NetWeaver ABAP stack's ICM layer is used for implementation of the SAP ArchiveLink protocol. This results in the elimination of any on-premise new infrastructure component for the hosting of the “cloud connector” or need for any OS-level software installation.

Second, a direct cloud connection is made through implementation of signed Representational State Transfer (REST) HTTP calls from within the connector through object-oriented ABAP language. This employs mapping of the ArchiveLink request/response to REST request/response streams within new classes in SAP that are used in certain embodiments of the invention.

Third, custom HTTP request-signing (e.g., based on a secure hash algorithm, such as the MD5/SHA algorithm) ABAP function modules are implemented within SAP, because conventional modules are not sufficient for securing REST requests in accordance with cloud-based storage services.

Fourth, encrypted persistence of the cloud service account keys within SAP is employed.

### Implementation of ArchiveLink Enabler

In certain embodiments, the ArchiveLink enabler's ArchiveLink service and related workbench objects are delivered as external transport files, e.g., having a transport number of E5BK900714. The transport can be imported into the target system in two ways: (i) from the operating system, through the SAP C program known as TP, or (ii) via STMS from within SAP.

If the transport is imported from the operating system through TP, then the following exemplary steps may be performed to perform the import. First, the appropriate command file (e.g., K900714.E5B) is copied to the directory cofile directory/usr/sap/trans/cofiles. Next, the corresponding data file (e.g., R900714.E5B) is copied to the directory/usr/sap/trans/data. The user then logs on to the application server as <SYSID>adm and navigates to the directory/usr/sap/trans/buffer (where <SYSID> represents the 3-digit system ID of the SAP system). If the file <SYSID> exists, then that file should be renamed to <SYSID>.save. The command “tp addtobuffer E5BK900714<SYSID> client=<client>” is then executed (where <client> represents the SAP client ID), and the command “tp import E5BK900714 <SYSID> client=<client>” is executed. Alternatively, transaction SM49 could also be used within SAP in order to execute an external command to import the transport, in which case the program to be started and the parameters would be the same as described above.

If the transport is installed from within SAP using STMS, then the following exemplary steps may be performed to perform the import. First, the user selects the import queue for the SAP system is selected. Next, the user selects from the menu bar “Extras,” “other Requests,” “Add.” The user enters the appropriate change request number (e.g., E5BK900714) and presses <Enter>, and that change request is added to the buffer of the SAP system. The user selects the specific request in the import queue and marks it (e.g., by placing the cursor on it). The user then chooses “Request,” “Import” from the menu bar, and the marked request will be displayed. Next, the user specifies the client into which the request is to be imported and presses <Enter>.

An overview of the steps to activate the ArchiveLink enabler and create a new content repository in an SAP system that already has the ArchiveLink service installed will now be provided.

The first step in configuring the ArchiveLink enabler is the activation of ICM, which is the HTTP service that provides an ArchiveLink interface to the SAP (local or remote) applications. The ICM framework provides the HTTP client and server components used for the operation of the ArchiveLink enabler. The ICM service can be activated, e.g., through transaction SICF (although the service name may vary depending on the cloud provider selected). To verify that the ICM framework in the host SAP system is functioning and available, the following exemplary steps can be performed: First, in transaction SM51, the service types Dialog and ICM are verified to be active for the corresponding application server. In transaction SMICM, it can then be observed whether the network components of this web application server (AS) are active for the current instance, and for which ports and protocols they have been activated. For a simple verification that the ICM or Internet Communication Framework (ICF) is functioning correctly the command “call/sap/bc/echo” can be entered using a web browser to access the URL http://<host_name>:<port_number>/sap/bc/echo.

For the ArchiveLink enabler to be able to access the cloud, a secure-socket layer (SSL) connection is used for secure communication. If SSL is not already active, then the following exemplary steps can be performed to activate SSL in the host SAP system: First, the SAP Cryptographic Library is installed in the $(DIR_EXECUTABLE) directory on the application server. If the SAP Cryptographic Library is not installed, then the SSL Server Personal Security Environment (PSE) and SSL client PSE nodes will not be included in the trust manager's PSE status section. Next, the following profile parameters are specified in the application server's instance profile:

| Parameter | Value |
|---|---|
| icm/server_port_<xx> | HTTPS port |
| icm/HTTPS/verify_client | 0: Do not use certificates |
| | 1: Allow certificates (default) |
| | 2: Require certificates |

If icm/HTTPS/verify_client=1, then any users who use Microsoft's Internet Explorer as their web browser and who do not possess a client certificate will receive an empty certificate selection dialog box when accessing the SAP Web AS. Therefore, if users will not be using client certificates for authentication, then this parameter should be set to the value 0. If changes are made to any of the ICM profile parameters, then the Interaction Center (IC) Manager should be restarted. The following exemplary profile parameters might be used in one embodiment of the invention:

| icm/server_port_2 | PROT = HTTPS, PORT = 443, |
|---|---|
| | TIMEOUT = 15 |
| icm/HTTPS/verify_client | 1 |

After the profile parameters are set, the PSEs for the SSL server are created and maintained using the following exemplary steps: First, the SSL server PSEs are created. Next, a certificate request is generated for each SSL server PSE, and each certificate request is sent to a certificate authority (CA) to be signed. The certificate request responses are then imported into the server's SSL server PSEs. The SSL server PSE's certificate list is then maintained.

After creating and maintaining the PSEs for the SSL server, the PSEs for the SSL client are created and maintained. If it is desired that the application server be able to use an anonymous identity to communicate with other web servers, then the PSEs for the anonymous SSL client PSE should be created and maintained. If it is desired that the application server be able to use individual identities to communicate with other Web servers using SSL, then individual SSL client PSEs should be created.

To define which SSL Client PSE to use, in transaction SM59, the HTTP destinations for the SAP Web Application Server are defined. In these destinations, it can be specified whether SSL should be used for the connection and which SSL client PSE the server should use. The cloud certificate chain can be imported into the default SSL client (i.e., by downloading the cloud chain from the corresponding cloud-provider account). The IC Manager should be restarted to ensure that any changes take effect.

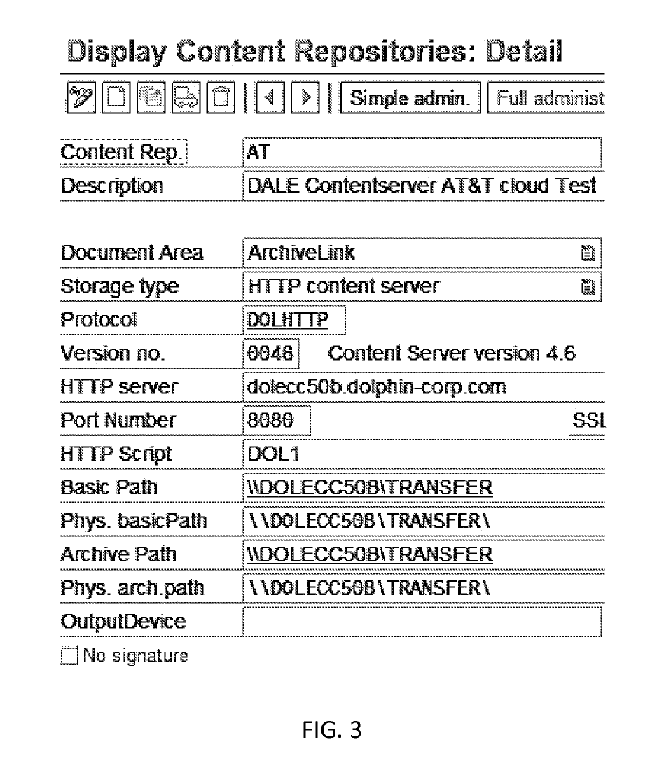

Following ICM activation and SSL creation and maintenance, the content repository can be created through standard SAP transaction OAC0, using the following exemplary steps: First, the user types “/nOAC0” to display the archive overview (content repositories). To switch to edit mode, the user clicks on “Display,” “Change.” The user clicks on “Create” to create a new archive. To modify an existing storage system, the user selects the system in the list and clicks on “Detail.” The user then clicks on “Full administration” and enters parameters, e.g., shown in FIG. 3, which is a screen view representing an exemplary archive employing AT&T Synaptic cloud as a cloud-storage provider.

As shown in FIG. 3, in the “Content Rep.” field, the user enters a two-character archive name (e.g., as capital letters and numbers) corresponding to the desired content repository. In the “Description” field, the user can enter a meaningful description of the archive, e.g., an indication of archive usage and an SAP CommonStore server/instance. In the “Document Area” field, the user enters “ArchiveLink” for an ArchiveLink archive or a corresponding document area for a KPro archive. In the “Storage type” field the user selects “HTTP Content Server.” For the “Protocol” field, the user enters the name of the protocol used for communication, e.g., HTTP. For the “Version no.” field, the user enters the version of the ArchiveLink interface being used, e.g., 0046. In the “HTTP server” field, the user enters the name of the SAP server hosting the ArchiveLink enabler. In the “Port number” field, the user enters the ICM HTTP port (or HTTPS port, if using SSL even internally). In the “HTTP Script” field, the user enters the ArchiveLink enabler ICM service name, e.g. “DOL1.”

In the “Basic Path” and “Archive Path” fields, the paths to the corresponding exchange directories are entered. For HTTP communication, the CommonStore server might not need access to this directory. The SAP application server stores the documents to be archived on the basic path. The ArchiveLink enabler makes documents requested by the SAP application available on the archive path. For data archiving, the exchange directory should be entered identically in the FILE transaction (or SAP Archive Administration (SARA)). It is noted that only the basic path and the archive path may be displayed in “Full administration” mode. In the “OutputDevice” field, the user specifies “ARCH” as the output device. The “No Signature” option permits URLs for this archive to be transmitted without encryption. When the “No Signature” option is disabled, the URL is given a secure key (SecKey) in which important data can be encrypted. It is noted that, when an archive is to operate in secure mode, SecKeys are used to transmit URLs. This is only for connection from the SAP Graphical User Interface (SAPGUI) to the SAP server and does not influence the communication to the cloud storage. Cloud communication is secure both at the transport level (e.g., SSL) and transactional level (e.g., using hash and request signature). Accordingly, the internal SecKey can be safely turned off to enhance performance without compromising the security of communications to the cloud. The user clicks on “Save” to complete creation of the content repository.

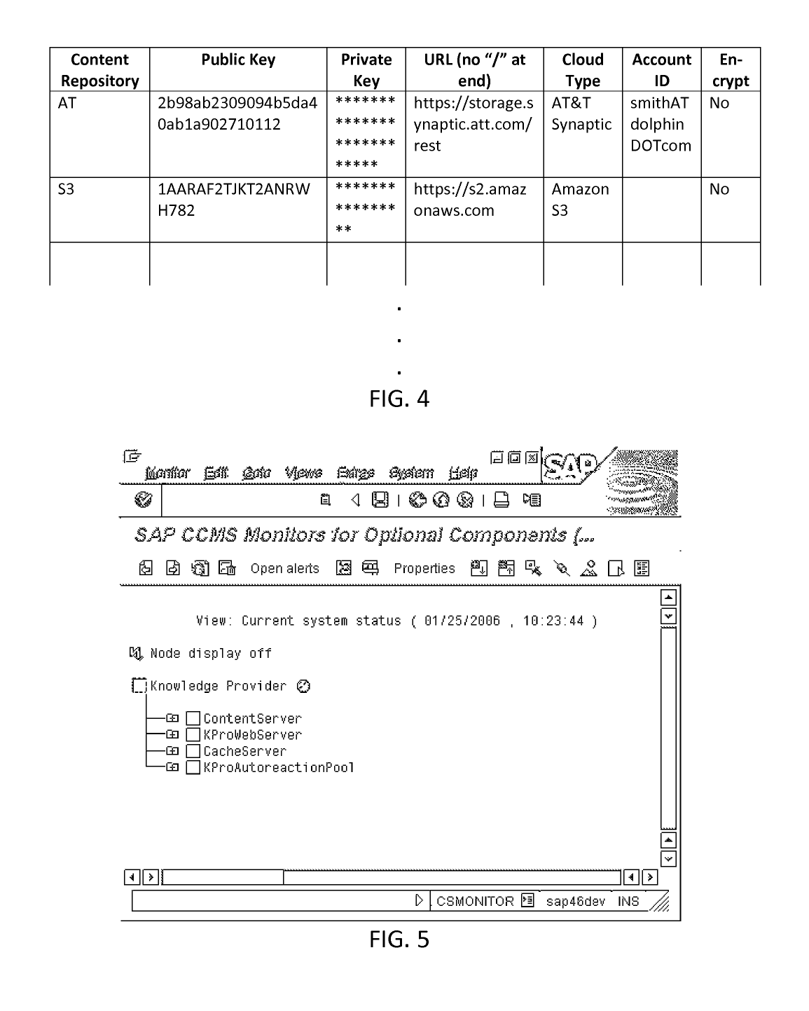

After the new content repository has been created, its content is mapped to a cloud-storage provider account, using the following exemplary steps: First, the user navigates to the customizing table maintenance transaction SM31, enters the table name “/DOL/ALE_CONN,” and clicks on “Maintain.” The user is presented with a screen view such as that shown in FIG. 4.

As shown in FIG. 4, the user is presented with a listing of already-configured content repositories in the “Content Rep.” field (which is a two-character archive name, or longer in the case of data access (DA) or KPro repositories). The user can create a new mapping by clicking on “New Entry” (or by copying a preexisting entry, if the user prefers to use the same cloud account as another existing archive) and entering information for the following fields: In the “Public Key” field, the user enters the public key for the user's cloud account. In the “Private Key” field, the user enters the private key for the user's cloud account, which key is masked on-screen and is stored as an encrypted value in the database, to protect confidentiality. In the “URL” field, the user enters the URL specified by the cloud provider (HTTPS communication to this URL should be allowed from the SAP application server). For the “Cloud Type” field, the user enters the type of cloud account, e.g., AT&T Synaptic, Amazon S3, Windows Azure Storage, CSE by Huawei Symantec, EMC Atmos, FilesAnywhere, Google Cloud Storage, or iCloud by Apple. In the “Account ID” field, the user enters the provider-specific user ID that is assigned as part of the cloud-account registration. In the “Encrypt” field, the user can specify whether content is further encrypted (in addition to SSL) for storage purposes (support for this flag may depend on the cloud provider). After the user saves the entry of the foregoing information, the user is ready to use the content repository (although the user could first perform a test connection from OAC0 and a communication test from RSHTTP90).

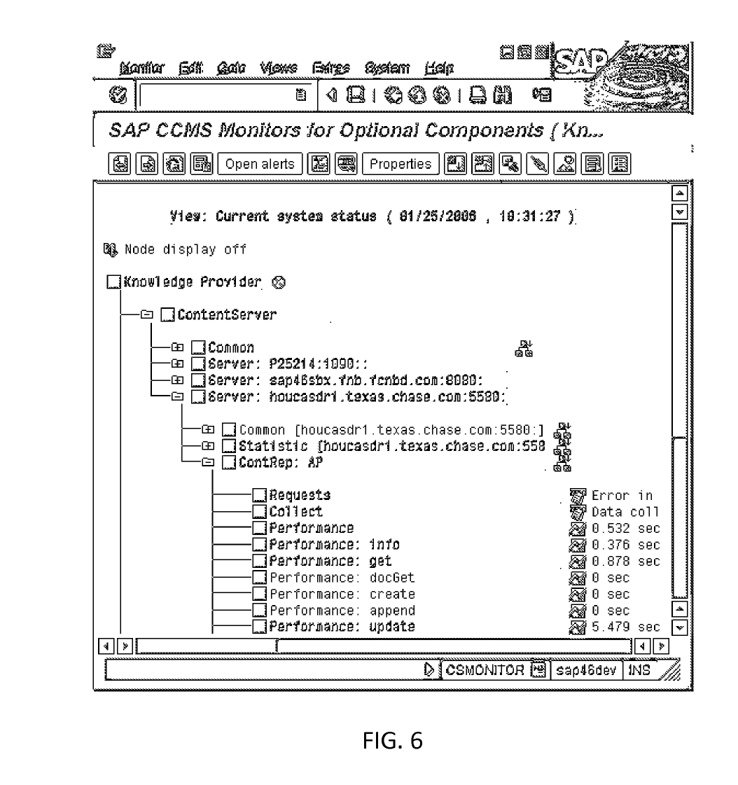

By default, newly-defined SAP content repositories have Performance Monitoring and Collection Monitoring enabled. This monitoring sends “random” document ID requests from SAP to the ArchiveLink service at defined periods. Since these requests are not for valid document ID's, the cloud will respond with a “404 Not Found” error. This error is what SAP expects, as this proves the content server is responsive. However, this monitoring can cause unnecessary traffic to the cloud and can makes it difficult to determine when an actual error is occurring. Therefore, after mapping the content repository to cloud-storage space, Performance and Collection Monitoring in the Content Server (CS) module should be turned off, using the following exemplary steps: First, the transaction CSMONITOR is initiated, and a window such as that shown in FIG. 5 is displayed. The appropriate Content Server, the appropriate CS server name, and the content repository (AP in this exasmple) are expanded and selected by the user, as shown in FIG. 6. Then, the user checks the “Collect” box, presses the “Properties” button, and selects the “Methods” tab, presses “Display,” then “Change,” and changes the field “Start the data collection method” to every 0 seconds, as shown in FIG. 7. The user clicks on “Save” and then “Back,” then checks the “Performance” box, presses the “Properties” button, selects the “Methods” tab, presses “Display,” then “Change,” and changes the field “Start the data collection method” to every 0 seconds, as shown in FIG. 8.

### Initially Enabling ArchiveLink Service

The following discussion provides an overview of enabling ArchiveLink on a new client SAP system in the case where no ArchiveLink applications have previously been used on that system. The procedures discussed in this section desirably are performed prior to the creation of a content repository, as discussed above. Initial customizing should be performed once for each SAP system. Each time a new or additional SAP system is introduced into the environment, this phase of the customizing should be repeated. Initial customizing involves establishing basic settings for SAP ArchiveLink for each SAP system. These settings may include, e.g.: setting up an archiving device, setting up queues, scheduling an ArchiveLink job, maintaining an ArchiveLink number range, maintaining the ArchiveLink basic settings for DMS (for printlists), and setting archive format parameters (for print lists containing hyperlinks) The following exemplary steps may be employed for enabling ArchiveLink.

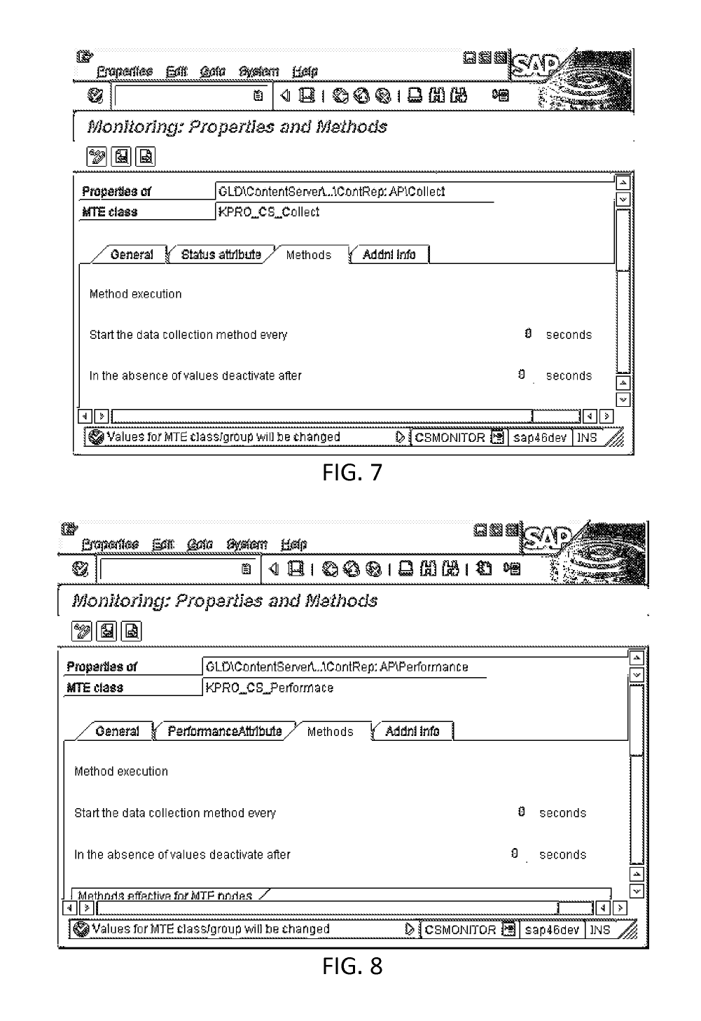

First, an archiving device should be set up. To archive print lists and outgoing documents, a virtual printer should be configured, which the SAP system uses to “print to the archive.” This is accomplished by executing the SPAD transaction, which displays a screen view such as that shown in FIG. 9. The user clicks on “Output devices,” then “Change,” and an overview of the output devices is displayed, which can now be edited. The user clicks on “Create,” and under “Output devices” enters “ARCH.” Next, the user selects the “Device/Attributes” tab, which displays a screen view such as that shown in FIG. 10. The user enters “ARCHLINK” under “Device Type,” and under “Spool Server” selects the appropriate server from a selection list. For “Device Class,” the user selects “Archiving program.” The user then enters “Authorization Group” information and may further enter any desired information in the “Model,” “Location,” and “Message” fields. Next, the user selects the “Access Method” tab, which displays a screen view such as that shown in FIG. 11. On this screen, the user selects “I: Archiving Device” as the “Host Spool Access Method,” then clicks “Save” and “Exit.”

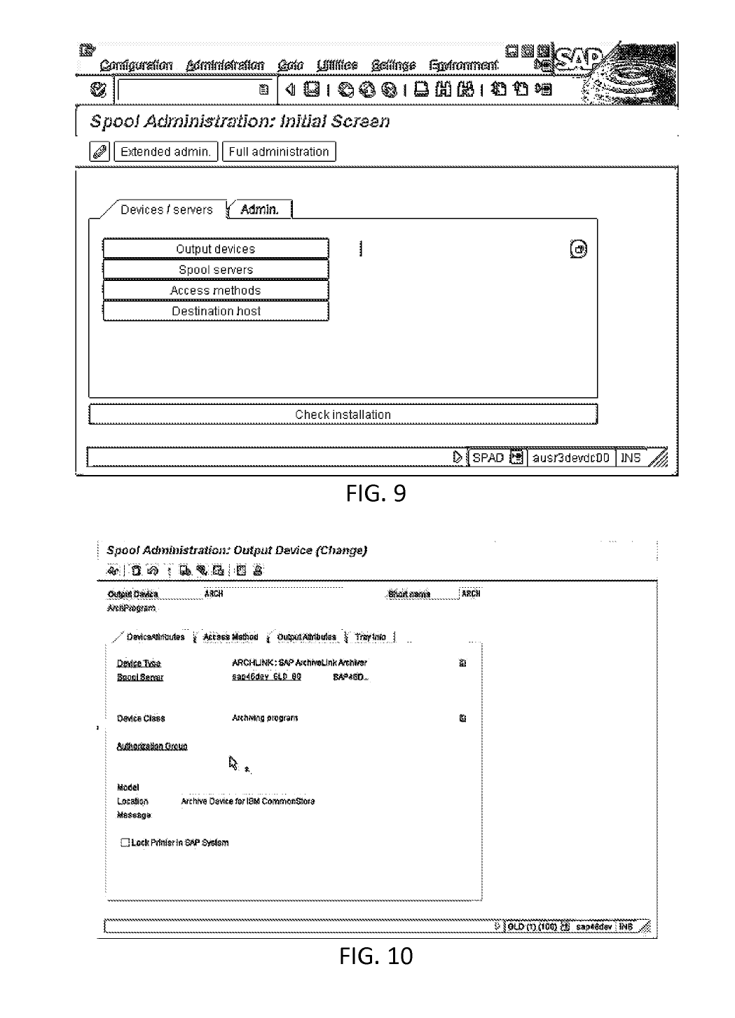

Next, storage queues are created. Since, in SAP, print lists and archive files from data archiving are stored and retrieved asynchronously, ArchiveLink does not wait for the storage or retrieval process to finish, but continues after receiving an order confirmation. This means that the actual order processing, particularly for large volumes of data, can take place at times when the system load is low. Queues for asynchronous processes should be set up and can be monitored in the ArchiveLink monitor. There are three queues for asynchronous processes and three associated error queues: First, anonymous archiving is performed via the storage queue (CARA queue), which contains orders for asynchronous archiving, which are forwarded to the archive. The associated error queue is also called the CARA-E queue. Second, storage confirmation is performed via the confirmation queue (CFBC queue), which contains feedback from the archive indicating that a storage operation has been successful. If errors occur during storage, then the appropriate messages are put into the error queue (CFBC-E queue). Third, asynchronous retrieval is performed via the retrieval queue (CFBA queue), which contains requirements for retrieving archived print lists and archive files. The related error queue is also called the CFBA-E queue. The queues may be created using the following exemplary steps: First, the OAQI transaction is executed, which displays a screen view such as that shown in FIG. 12. Next, the user enters an “X” for each queue. The user then enters the SAP user name of the archive administrator or the SAP system administrator as the Queue Administrator, i.e., the user who receives the queue error messages. The user clicks on “Execute,” and then “Exit/Do Not Save.”

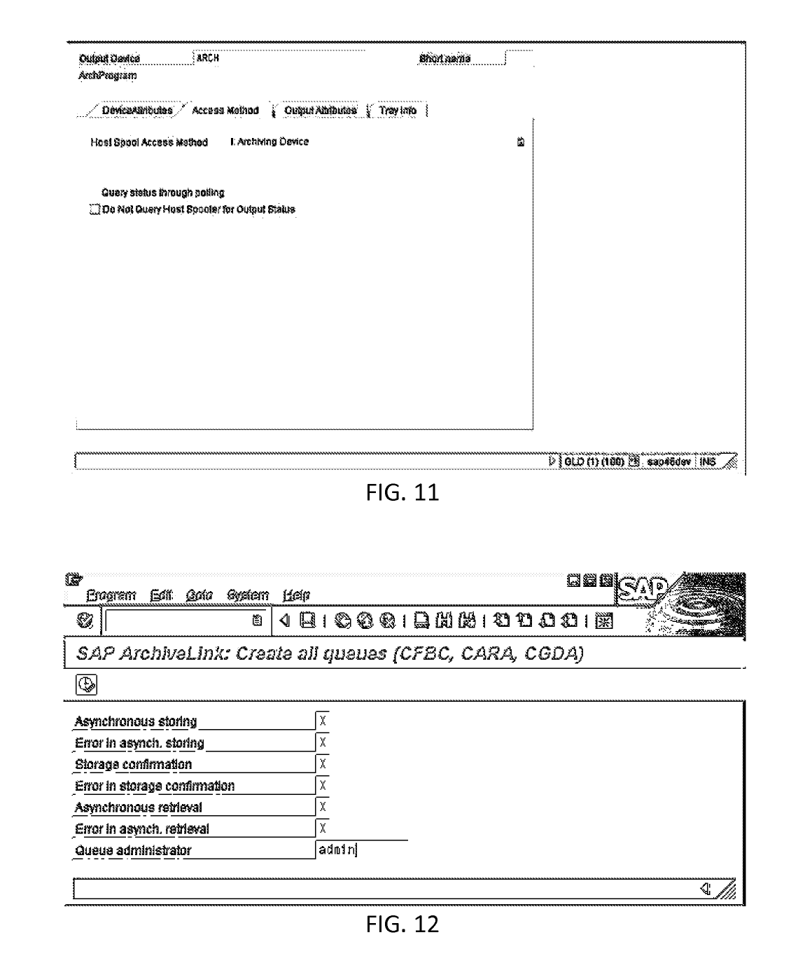

Next, an ArchiveLink job should be scheduled. The ArchiveLink job processes the files in the queues for asynchronous processes and should run as a scheduled job every five minutes. First, the user executes the OAB4 or OAAT transaction, which displays a screen view such as that shown in FIG. 13. Next, the user creates the job step by clicking on “ABAP program” and entering the name of the job, “ilqbatch.” The user then clicks “save,” enters “ARCHIVELINK” in the “Job name” field, and enters “C” in the “Job class” field. The user then accepts these settings, clicks on “Start condition,” clicks on “Immediate,” and activates the “Periodic job” option, which displays a screen view such as that shown in FIG. 14. The user then clicks on “Period values,” clicks on “Other period,” enters “5 minutes,” and then clicks on “Save” four times, to save all entries.

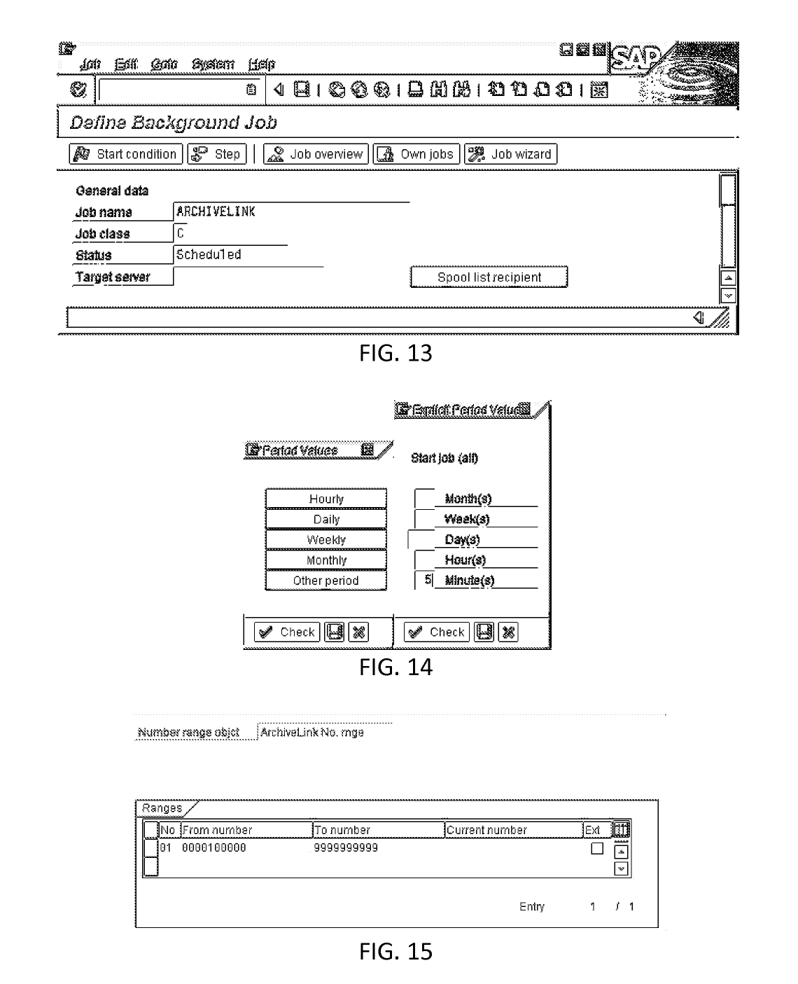

Next, an ArchiveLink number range should be maintained. For SAP ArchiveLink, a number-range interval for generating unique file names and unique order numbers for asynchronous orders can be set up using the following exemplary steps: First, the user executes the OANR transaction, which displays a screen view such as that shown in FIG. 15. The user clicks on “Intervals,” then “Interval,” then enters a range number “01” from the number “100000” to the number “9999999999.” The “Ext” checkbox is for specifying an external range number and should remain unchecked for this internal number range. The user then clicks on “Save.”

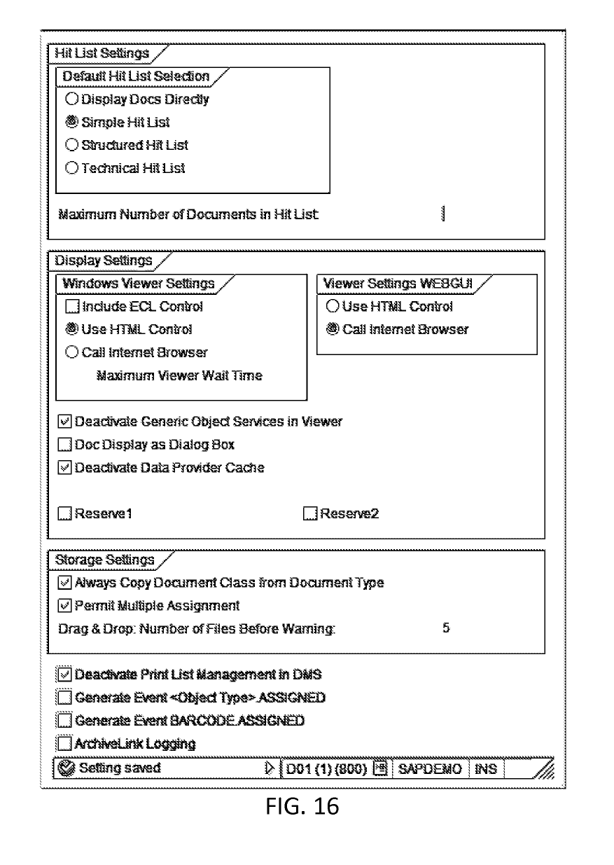

Next, ArchiveLink basic settings for DMS should be maintained. To archive print lists in CommonStore, the print list management for DMS should be deactivated. DMS is not used in mySAP CRM. The DMS settings can be set up using the following exemplary steps: First, the user executes the OAG1 transaction, which displays a screen view such as that shown in FIG. 16. (For SAP basis 6.20 only, the user enters “sapsupport” in the transaction field and presses the Enter key.) The user then ensures that the following options are activated: “Deactivate Print List Management in DMS,” and “Generate Event <Object Type. ASSIGNED.” The user then clicks on “Save.”

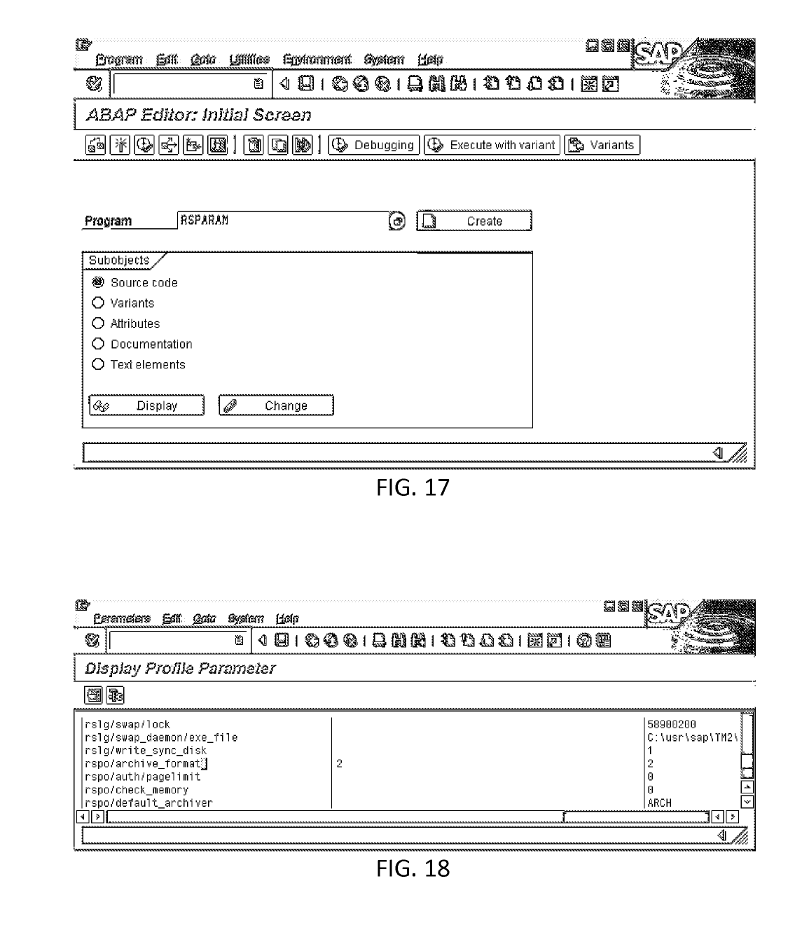

Next, parameters can optionally be set for the archive format. To archive print lists containing hyperlinks, attribute search index and/or color data, the user should set the rspo/archive_format parameter to 2 in the SAP instance profile. This parameter can have one of two values: (i) Format 1 contains ASCII characters, as well as line feed and form feed as control characters, and (ii) Format 2 contains print controls, preceding columns, comments, and DARC index lines (i.e., index lines that define the position in a subobject which is marked as hypertext). The default value is 2, and this value should be changed as appropriate, which can be done using the following exemplary steps: First, the user executes the SE38 transaction, which displays a screen view such as that shown in FIG. 17. The user then enters the report name “RSPARAM,” clicks on “Execute,” and then again on “Execute,” which displays a screen view such as that shown in FIG. 18. A list is shown, containing the rspo/archive_format parameter together with its value. This parameter can be modified either in the profile file itself, using an editor, specifying the following path to the profiles (where <SID>_DVEBMGS<INS>_<r3_host> is the name of the instance profile): usr/sap/<SID>/SYS/profile/<SID>_DVEBMGS<INS>_<r3_host>. Alternatively, this parameter can be modified using the SAP profile maintenance module, by executing transaction RZ10. After modifying the profile parameters, the SAP system should be restarted.

### Alternative Embodiments

Although embodiments of the invention have been described herein as being implemented in an SAP environment, it should be recognized that the invention may have utility in other hardware and software environments suitable for cloud storage connection. Accordingly, generic terms such as “enabler” or “archive module” and the like may be used interchangeably herein with vendor-specific terms such as “ArchiveLink enabler” or “SAP-driven archive module” component and the like, respectively, as described herein, and it should be understood that such generic and vendor-specific terms should be construed as referring to components having equivalent or similar structure and/or functionality to one another.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the invention. When implemented on a general-purpose processor, the program code segments combine with the processor to provide a unique device that operates analogously to specific logic circuits.

It will be appreciated by those skilled in the art that although the functional components of the exemplary embodiments of the system of the present invention described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present invention. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the invention as described herein may be implemented in one or more computers residing on a network transaction server system, and input/output access to embodiments of the invention may include appropriate hardware and software (e.g., personal and/or mainframe computers provisioned with Internet wide area network communications hardware and software (e.g., CQI-based, FTP, Netscape Navigator™, Mozilla Firefox™, Microsoft Internet Explorer™, or Apple Safari™ HTML Internet-browser software, and/or direct real-time or near-real-time TCP/IP interfaces accessing real-time TCP/IP sockets) for permitting human users to send and receive data, or to allow unattended execution of various operations of embodiments of the invention, in real-time and/or batch-type transactions. Likewise, the system of the present invention may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, or Apple Safari™). Thus, the present invention may be appropriately adapted to include such communication functionality and Internet browsing ability. Additionally, those skilled in the art will recognize that the various components of the server system of the present invention may be remote from one another, and may further include appropriate communications hardware/software and/or LAN/WAN hardware and/or software to accomplish the functionality herein described.

Each of the functional components of the present invention may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10 g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the invention may be server-based and may reside on hardware supporting an operating system such as Microsoft Windows NT/2000™ or UNIX.

Components of a system consistent with embodiments of the invention may include mobile and non-mobile devices. Mobile devices that may be employed in the present invention include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iPhone operating systems, Windows CE™ handheld computers, or other handheld computers (possibly including a wireless modem), as well as wireless, cellular, or mobile telephones (including GSM phones, J2ME and WAP-enabled phones, Internet-enabled phones and data-capable smart phones), one- and two-way paging and messaging devices, laptop computers, etc. Other telephonic network technologies that may be used as potential service channels in a system consistent with embodiments of the invention include 2.5G cellular network technologies such as GPRS and EDGE, as well as 3G technologies such as CDMA1xRTT and WCDMA2000, and 4G technologies. Although mobile devices may be used in embodiments of the invention, non-mobile communications devices are also contemplated by embodiments of the invention, including personal computers, Internet appliances, set-top boxes, landline telephones, etc. Clients may also include a PC that supports Apple Macintosh™, Microsoft Windows 95/98/NT/ME/CE/2000/XP/Vista/7™, a UNIX Motif workstation platform, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to the present invention. These personal computers may run the Unix, Microsoft Windows NT/2000™ or Windows 95/98/NT/ME/CE/2000/XP/Vista/7™ operating systems. The aforesaid functional components of a system according to the present invention may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to the present invention may also be part of a larger system including multi-database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present invention to achieve additional functionality.

In one embodiment, source code may be written in an object-oriented programming language using relational databases. Such an embodiment may include the use of programming languages such as C++ and toolsets such as Microsoft's .Net™ framework. Other programming languages that may be used in constructing a system according to the present invention include Java, HTML, Perl, UNIX shell scripting, assembly language, Fortran, Pascal, Visual Basic, and QuickBasic. Those skilled in the art will recognize that the present invention may be implemented in hardware, software, or a combination of hardware and software.

Accordingly, the terms “computer” or “system,” as used herein, should be understood to mean a combination of hardware and software components including at least one machine having a processor with appropriate instructions for controlling the processor. The terms “computer” or “system” can be used to refer to more than a single computing device, e.g., multiple personal computers, or one or more personal computers in conjunction with one or more other devices, such as a router, hub, packet-inspection appliance, firewall, etc.

It should also be appreciated from the outset that one or more of the functional components may alternatively be constructed out of custom, dedicated electronic hardware and/or software, without departing from the present invention. Thus, the present invention is intended to cover all such alternatives, modifications, and equivalents as may be included within the spirit and broad scope of the invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

Although the invention has been set forth in terms of the exemplary embodiments described herein and illustrated in the attached documents, it is to be understood that such disclosure is purely illustrative and is not to be interpreted as limiting. Consequently, various alterations, modifications, and/or alternative embodiments and applications may be suggested to those skilled in the art after having read this disclosure. Accordingly, it is intended that the invention be interpreted as encompassing all alterations, modifications, or alternative embodiments and applications as fall within the true spirit and scope of this disclosure.

It will be further understood that various changes in the details, materials, and arrangements of the parts which have been described and illustrated in order to explain the nature of this invention may be made by those skilled in the art without departing from the scope of the invention as expressed in the following claims.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

We claim:

1. A business-software application system comprising:
a first application server configured to execute a plurality of applications and comprising an archiving module; and
an enabler adapted to exchange application data with (i) the archiving module, and, (ii) via a secure connection, a cloud-storage repository.

2. The invention of claim 1, wherein the business-software application system is an SAP system, and the enabler employs the ArchiveLink protocol to communicate with the archiving module.

3. The invention of claim 1, wherein the enabler is adapted to make signed Representational State Transfer (REST) HTTP calls through the ABAP language.

4. The invention of claim 1, wherein the enabler is adapted to exchange application data with the archiving module using an HTTP protocol.

5. The invention of claim 1, further comprising one or more input clients for receiving application data.

6. The invention of claim 5, wherein the one or more input clients are adapted to receive application data from a local file share.

7. The invention of claim 5, wherein the one or more input clients are adapted to provide application data to the enabler, and the enabler is adapted to store application data on the cloud-storage repository.

8. The invention of claim 5, wherein the first application server further comprises one or more input modules, and the one or more input clients are adapted to provide application data to the one or more input modules.

9. The invention of claim 8, wherein the one or more input clients are adapted to provide application data to the one or more input modules in a Remote Function Call (RFC) and/or an Object Linking and Embedding (OLE) format.

10. The invention of claim 8, wherein the one or more input clients are adapted to provide application data to the enabler using an HTTP protocol.

11. The invention of claim 1, further comprising a firewall disposed between the enabler and the cloud-storage repository.

12. The invention of claim 1, further comprising a document viewer/browser, wherein the enabler is adapted to provide application data to the document viewer/browser.

13. The invention of claim 12, wherein the enabler is adapted to exchange application data with the document viewer/browser using an HTTP protocol.

14. The invention of claim 1, wherein the enabler resides on the first application server.

15. The invention of claim 1, further comprising a second application server configured to execute a plurality of applications and in communication with the first application server, wherein the enabler resides on the second application server.

16. The invention of claim 1, wherein the enabler is adapted to exchange, with at least one other component of the business-software application system, an encrypted persistence of account information for the cloud-storage repository.

17. An enabler-implemented method for a business-software application system to access a cloud storage repository, the business-software application system comprising:
a first application server configured to execute a plurality of applications and comprising an archiving module; and
an enabler adapted to exchange application data with (i) the archiving module, and, (ii) via a secure connection, a cloud-storage repository, wherein the method comprises at least one of:
(i) the enabler receiving application data from the archiving module and providing the received application data to the cloud-storage repository; and
(ii) the enabler receiving application data from the cloud-storage repository and providing the received application data to the archiving module.

18. The invention of claim 17, wherein the business-software application system is an SAP system, and the enabler employs the ArchiveLink protocol to communicate with the archiving module.

19. A non-transitory machine-readable medium having encoded thereon program code, wherein, when the program code is executed by a machine, the machine implements a method for a business-software application system to access a cloud storage repository, the business-software application system comprising:
a first application server configured to execute a plurality of applications and comprising an archiving module; and
an enabler adapted to exchange application data with (i) the archiving module, and, (ii) via a secure connection, a cloud-storage repository, wherein the method comprises at least one of:
(i) the enabler receiving application data from the archiving module and providing the received application data to the cloud-storage repository; and
(ii) the enabler receiving application data from the cloud-storage repository and providing the received application data to the archiving module.

20. The invention of claim 19, wherein the business-software application system is an SAP system, and the enabler employs the ArchiveLink protocol to communicate with the archiving module.
